(19) United States
(12) Patent Application Publication
(10) Pub. No.: US 2025/0388394 A1
(43) Pub. Date: Dec. 25, 2025

(54) OBJECT RETRIEVAL AND STORAGE DEVICE, OBJECT RETRIEVAL AND STORAGE METHOD, AND NON-TRANSITORY STORAGE MEDIUM

(71) Applicant: JVCKENWOOD Corporation, Yokohama-shi (JP)

(72) Inventor: Shinnosuke Yamamoto, Yokohama-shi (JP)

(21) Appl. No.: 19/246,975

(22) Filed: Jun. 24, 2025

(30) Foreign Application Priority Data
Jun. 25, 2024 (JP) 2024-102358

(51) Int. Cl. B65G 1/04; B60N 2/02; B60N 2/24; B60N 2/58; B60R 7/02; G06V 20/59

(52) U.S. Cl. CPC B65G 1/04; B60N 2/0244; B60N 2/24; B60N 2/58; B60R 7/02; G06V 20/593; B65G 2203/0233; B65G 2203/041

(57) ABSTRACT

An object retrieval and storage device includes: a storage box in which an object is stored; a retrieval mechanism configured to move the object which is present on a seat to retrieve the object into the storage box; an imager configured to capture an image which includes a condition of the seat; and an object detecting unit configured to, based on the captured image, determine whether or not the object is present on the seat, wherein the retrieval mechanism is further configured to, when the object detecting unit determines that the object is present on the seat, move the object to put the object into the storage box.

### CROSS-REFERENCE TO RELATED APPLICATIONS

This application claims priority from Japanese Patent Application No. 2024-102358 filed on Jun. 25, 2024, the entire contents of which are incorporated by reference herein in its entirety.

### FIELD

The present application is related to an object retrieval and storage device, an object retrieval and storage method, and a non-transitory storage medium.

### BACKGROUND

In case a user leaves something behind in a self-driving taxi, unlike in a manned taxi in which the driver can become aware of a thing left behind and can retrieve and store it, since there is no driver in a self-driving taxi, even when the thing left behind is detected by an in-vehicle camera, it is not possible to actually retrieve and store it.

For example, in Japanese Patent Application Laid-open No. 2019-197570 mentioned below, a vehicle floor structure is disclosed that includes a floor member constituting a floor surface of a vehicle interior, a retrieving unit with an opening and a storage portion; and a support member for supporting the floor member in an inclinable manner; and that is configured in such a way that an end portion of the support member positioned below the floor member is either continuous with the opening of the retrieving unit or positioned above the opening.

However, the vehicle floor structure disclosed in Japanese Patent Application Laid-open No. 2019-197570 is premised on a ride sharing service that is used by a large number of unspecified users, and is intended to simplify a task of cleaning trash inside the vehicle by collecting the trash at one place with inclining the vehicle floor. Thus, the vehicle floor structure is not designed to retrieve a thing left behind in an unmanned state.

### SUMMARY

An object retrieval and storage device, an object retrieval and storage method, and a non-transitory storage medium are disclosed.

According to one aspect of the present application, there is provided an object retrieval and storage device comprising: a storage box in which an object is stored; a retrieval mechanism configured to move the object which is present on a seat to retrieve the object into the storage box; an imager configured to capture an image which includes a condition of the seat; and an object detecting unit configured to, based on the captured image, determine whether or not the object is present on the seat, wherein the retrieval mechanism is further configured to, when the object detecting unit determines that the object is present on the seat, move the object to put the object into the storage box.

According to one aspect of the present application, there is provided an object retrieval and storage method implemented in an object retrieval and storage device that includes: a storage box in which an object is stored; a retrieval mechanism configured to move the object which is present on a seat to retrieve the object into the storage box; and an imager configured to capture an image which includes a condition of the seat, the object retrieval and storage method comprising: determining, based on the captured image, whether or not the object is present on the seat; and moving the object to put the object into the storage box when the object is determined to be present on the seat.

According to one aspect of the present application, there is provided a non-transitory storage medium that stores a computer program for an object retrieval and storage device that includes: a storage box in which an object is stored; a retrieval mechanism configured to move the object which is present on a seat to retrieve the object into the storage box; and an imager configured to capture an image which includes a condition of the seat, the program causing a computer to execute: determining, based on the captured image, whether or not the object is present on the seat; and moving the object when it is determined that the object is present on the seat to put the object into the storage box when the object is determined to be present on the seat.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram for explaining an overview of an object retrieval and storage system according to the present application;

FIG. 2 is a diagram illustrating an exemplary configuration of the object retrieval and storage system according to the present application;

FIG. 3 is a schematic diagram illustrating a first state of an object retrieval and storage device according to a first embodiment of the present application;

FIG. 4 is a schematic diagram illustrating a second state of the object retrieval and storage device according to the first embodiment of the present application;

FIG. 5 is a schematic diagram illustrating a third state of the object retrieval and storage device according to the first embodiment of the present application;

FIG. 6 is a schematic diagram illustrating a fourth state of the object retrieval and storage device according to the first embodiment of the present application;

FIG. 7 is a schematic diagram illustrating a first state of an object retrieval and storage device according to a second embodiment of the present application;

FIG. 8 is a schematic diagram illustrating a second state of the object retrieval and storage device according to the second embodiment of the present application;

FIG. 9 is a schematic diagram illustrating a third state of the object retrieval and storage device according to the second embodiment of the present application;

FIG. 10 is a schematic diagram illustrating a fourth state of the object retrieval and storage device according to the second embodiment of the present application;

FIG. 11 is a diagram illustrating an exemplary configuration of a control device of the object retrieval and storage device according to the present application;

FIG. 12 is a diagram illustrating an example of information stored in an object detection information storage in the control device according to the present application;

FIG. 13 is an example of information stored in an image recognition model storage according to the present application;

FIG. 14 is a diagram illustrating an exemplary configuration of a user terminal according to the present application; and

FIG. 15 is a diagram illustrating an exemplary configuration of a server device according to the present application.

### DETAILED DESCRIPTION OF THE PREFERRED EMBODIMENTS

Exemplary embodiments of the present application are described below in detail with reference to the accompanying drawings. However, the present application is not limited by the embodiments described below.

### Overview of an Object Retrieval and Storage System

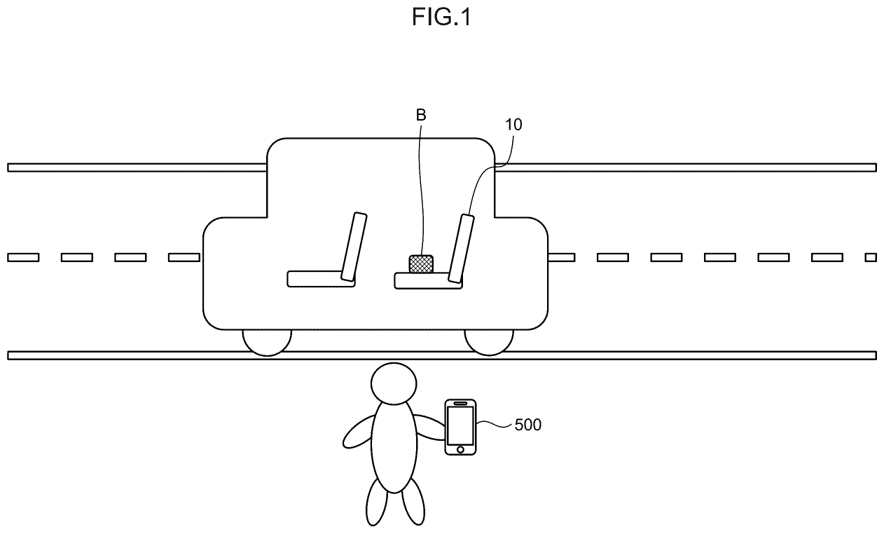

Firstly, explained below with reference to FIG. 1 is an overview of an object retrieval and storage system 1 according to the present application. FIG. 1 is a diagram for explaining the overview of the object retrieval and storage system according to the present application.

As illustrated in FIG. 1, the object retrieval and storage system 1 according to the present application is installed in, for example, a self-driving vehicle. In response to a request made by the user, a self-driving vehicle calculates a travel route from a current location to a destination and takes that travel route to travel from the current location to the destination. Once the self-driving car reaches the destination, the user gets off the self-driving car. However, there may be a case in which the user carelessly leaves an object (for example, a thing left behind such as a wallet) in the self-driving vehicle.

In that case, the object retrieval and storage system 1 detects the object left behind by the user in the self-driving vehicle, retrieves that object, and stores it in a safe place. As a result, even when a user leaves an object in a self-driving vehicle that is driven in an unmanned manner, the object left behind can be automatically detected and retrieved before another user gets in the vehicle, and can be stored in a safe place.

### Configuration of an Object Retrieval and Storage System

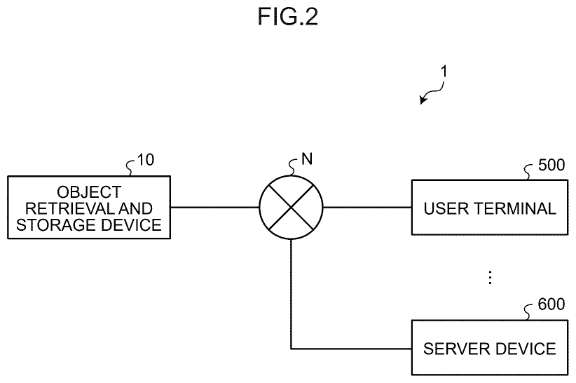

Explained below with reference to FIG. 2 is a configuration of the object retrieval and storage system 1 according to the present application. FIG. 2 is a diagram illustrating an exemplary configuration of the object retrieval and storage system according to the present application. As illustrated in FIG. 2, the object retrieval and storage system 1 includes an object retrieval and storage device 10, a user terminal 500, and a server device 600.

The object retrieval and storage device 10 is a device that retrieves an object and stores it. Regarding the configuration of the object retrieval and storage device 10, the explanation is given later. For example, the object retrieval and storage device 10 can be installed in a self-driving vehicle or can be installed as a seat in a movie theatre.

The user terminal 500 is an information processing device used by a user. For example, the user terminal 500 can be an information processing device such as a smartphone, a tablet terminal, a wearable terminal, a cellular phone, or a personal digital assistant (PDA). As illustrated in FIG. 1, the object retrieval and storage system 1 can include multiple user terminals 500.

The server device 600 is an information processing device that performs a variety of information processing. For example, the server device 600 can be implemented using an information processing device such as a personal computer (PC), a work station (WS), or a computer equipped with functions of a server.

A network N connects the object retrieval and storage device 10, the user terminal 500, and the server device 600 in a mutually communicable manner using a wired connection or a wireless connection. In the case of using a wired connection, the network N can be implemented using Ethernet (registered trademark) defined in IEEE 802.3. In the case of using a wireless connection, the network N can be implemented using a wireless LAN (LAN stands for Local Area Network) defined in IEEE 802.11 or using Bluetooth (registered trademark).

### First Embodiment

### Configuration of an Object Retrieval and Storage Device

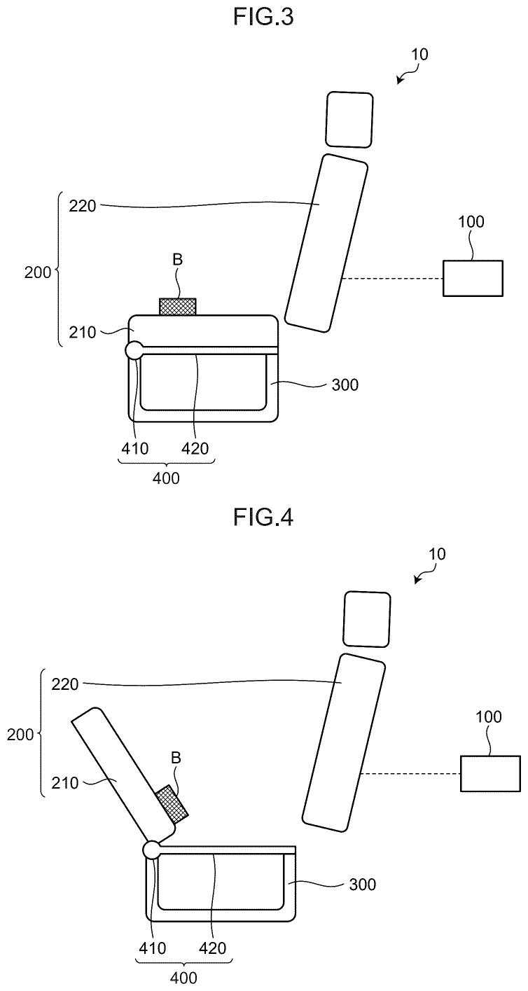

Given below is an explanation of a configuration of the object retrieval and storage device 10 according to a first embodiment of the present application. FIG. 3 is a schematic diagram illustrating a first state of the object retrieval and storage device according to the first embodiment of the present application. As illustrated in FIG. 3, the object retrieval and storage device 10 according to the first embodiment includes a control device 100, a seat 200, a storage box 300, and a retrieval mechanism 400. Meanwhile, the control device 100 is used in common in the first embodiment and a second embodiment. Hence, the explanation of the control device 100 is given later.

The seat 200 is the seat on which the user sits. The seat 200 according to the first embodiment includes a sitting portion 210 on which the user sits, and includes a backrest 220 with which a back of the user makes contact. For example, the seat 200 is made of a frame that serves as a basic framework, urethan that serves as an internal cushioning, and a trim cover that is made of leather or a fabric and covers a cushioning.

The storage box 300 is a container for storing an object B. The storage box 300 according to the first embodiment includes a housing portion in which the object B is housed, and an opening formed above the housing portion. Thus, the object B is housed in the housing portion through the opening. According to the first embodiment, the storage box 300 is an elongated container having the same length as the length in a front-back direction of the seat 200. For example, the storage box 300 is provided under the sitting portion 210 of the seat 200. For that reason, without gaining an authentication to access the storage box 300, the user cannot insert a hand inside the storage box 300.

The retrieval mechanism 400 is a mechanism for enabling movement of the seat 200. The retrieval mechanism 400 includes a fulcrum portion 410, a sliding portion 420, and a movable portion (not illustrated).

The fulcrum portion 410 serves as a fulcrum point for rotational movement of the sitting portion 210 of the seat 200. That is, the fulcrum portion 410 supports the sitting portion 210 of the seat 200 in an inclinable manner. The fulcrum portion 410 not only can support the sitting portion 210 of the seat 200, but also can enable variation in an angle of the support. The fulcrum portion 410 defines a rotational trajectory of the sitting portion 210 of the seat 200 in such a way that, for example, the sitting portion 210 of the seat 200 rotates around the fulcrum portion 410 and becomes inclined. Moreover, the fulcrum portion 410 rotatably fixes the sitting portion 210 of the seat 200 in such a way that, when the sitting portion 210 of the seat 200 is positioned at the foremost portion of the sliding portion 420, the fulcrum portion 410 serves as the fulcrum point for the rotational movement.

The sliding portion 420 serves as a constraint on sliding movement of the sitting portion 210 of the seat 200. For example, the sliding portion 420 can be a guide rail. The sliding portion 420 causes the sitting portion 210 of the seat 200 to slide along the guide rail so that the sitting portion 210 can move in the front-back direction of the seat 200.

The movable portion (not illustrated) is responsible for the sliding movement of the seat 200 and the rotational movement of the seat 200 around the fulcrum portion 410. The movable portion can be implemented using an actuator that is a driving device of the electrical type, or the magnetic type, or the mechanical type for enabling the sliding movement of the sitting portion 210 of the seat 200 in the front-back direction of the seat 200; and using an actuator that is of the identical type of the abovementioned actuator and that enables rotation of the sitting portion 210 of the seat 200 around the fulcrum portion 410.

### Operations Performed in the Object Retrieval and Storage Device

Explained below with reference to FIGS. 3 to 6 are operations of the object retrieval and storage device 10 according to the first embodiment of the present application. Firstly, as explained earlier with reference to FIG. 3, assume that a user gets off the seat 200 while leaving an object B onto the sitting portion 210 of the seat 200. In that case, the object retrieval and storage device 10 detects the object B and drives the retrieval mechanism 400.

Then, the object retrieval and storage device 10 switches to a second state as illustrated in FIG. 4. FIG. 4 is a schematic diagram illustrating the second state of the object retrieval and storage device according to the first embodiment of the present application. That is, the object retrieval and storage device 10 moves the sitting portion 210 of the seat 200 in the front direction of the seat 200 along the sliding portion 420. Once the sitting portion 210 of the seat 200 is moved to the forefront of the sliding portion 420, the object retrieval and storage device 10 rotates the sitting portion 210 of the seat 200 around the fulcrum portion 410.

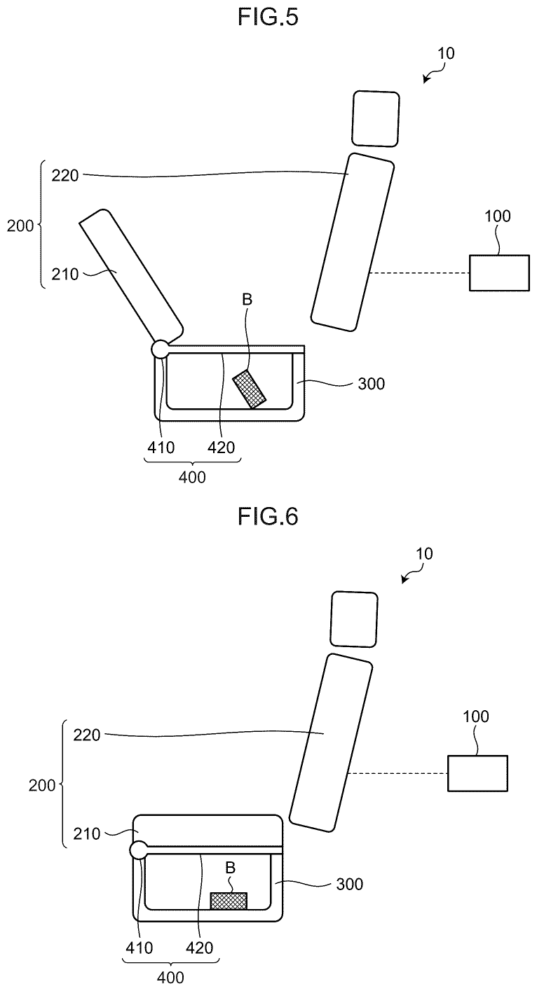

As a result, the object retrieval and storage device 10 switches to a third state as illustrated in FIG. 5. FIG. 5 is a schematic diagram illustrating the third state of the object retrieval and storage device according to the first embodiment of the present application. That is, accompanying the rotation of the sitting portion 210 of the seat 200, the object B placed on the sitting portion of the seat 200 of the object retrieval and storage device 10 slips from the sitting portion 210 of the seat 200 and is retrieved into the storage box 300.

Then, the object retrieval and storage device 10 switches to a fourth state as illustrated in FIG. 6. FIG. 6 is a schematic diagram illustrating the fourth state of the object retrieval and storage device according to the first embodiment of the present application. Thus, once it is confirmed that the object B has entered the storage box 300, the object retrieval and storage device 10 rotates the sitting portion 210 of the seat 200 in the opposite direction to the earlier direction, causes the sitting portion 210 of the seat 200 to slide along the sliding portion 420, and restores the sitting portion 210 of the seat 200 to the original position.

As a result, even when an object B is left behind on the seat 200, that object B can be automatically detected and, by moving the sitting portion 210 of the seat 200, the object B can be retrieved and stored in a safe place.

### Second Embodiment

### Configuration of the Object Retrieval and Storage Device

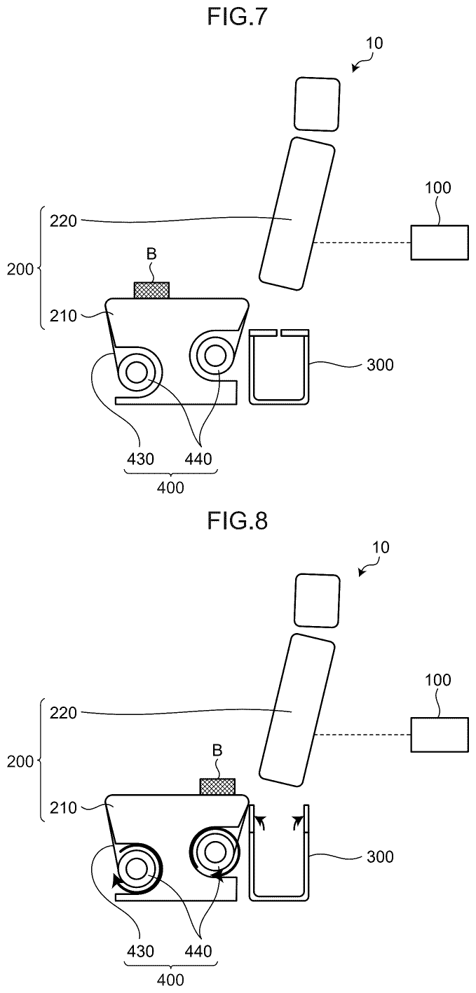

Given below is an explanation of a configuration of the object retrieval and storage device 10 according to a second embodiment of the present application. FIG. 7 is a schematic diagram illustrating a first state of the object retrieval and storage device according to the second embodiment of the present application. As illustrated in FIG. 7, the object retrieval and storage device 10 according to the second embodiment includes the control device 100, the seat 200, the storage box 300, and the retrieval mechanism 400. As explained earlier, the control device 100 is used in common in the first embodiment and the second embodiment, and the explanation of the control device 100 is given later. Moreover, although the seat 200 according to the second embodiment has a different shape from a shape of the seat 200 according to the first embodiment, the configuration is identical. Hence, the configuration is not explained again.

The storage box 300 according to the second embodiment is provided below the backrest 220 of the seat 200. According to the second embodiment, the storage box 300 includes a housing portion in which an object B is housed, and a cover portion that is disposed at an upper part of the housing portion. In the second embodiment, when it is detected that the object B is present on the sitting portion 210 of the seat 200, the cover portion of the storage box 300 opens.

The retrieval mechanism 400 according to the second embodiment includes a cover 430 for covering the sitting portion 210, circular rollers 440 for winding the cover 430, and a movable portion.

The cover 430 is made of a fabric that is spread to cover the sitting portion 210. Dimensions of the cover 430 may be sufficiently large to cover an entire surface of the sitting portion 210 of the seat 200.

The rollers 440 wind the cover 430 and retrieve it. Each roller 440 is made with a shaft which includes bearings such as ball bearings at both ends, and an outer edge portion around which the cover 430 is wound. In an anterior side and a posterior side below the sitting portion 210 of the seat 200, two rollers 440 can be disposed around which the two ends of the cover 430 are wound.

The movable portion according to the second embodiment includes an electrical motor for rotating rollers 440. The movable portion rotates the electrical motor based on a control signal transmitted from the control device 100.

### Operations Performed in the Object Retrieval and Storage Device

Explained below with reference to FIGS. 7 to 10 are operations performed in the object retrieval and storage device 10 according to the second embodiment of the present application. Firstly, as explained earlier with reference to FIG. 7, assume that a user gets off the seat 200 while leaving the object B onto the sitting portion 210 of the seat 200. In that case, the object retrieval and storage device 10 detects the object B and drives the retrieval mechanism 400.

Then, the object retrieval and storage device 10 according to the second embodiment switches to a second state as illustrated in FIG. 8. FIG. 8 is a schematic diagram illustrating a second state of the object retrieval and storage device according to the second embodiment of the present application. That is, the object retrieval and storage device 10 rotates the rollers 440 so as to move the cover 430 toward the posterior side of the seat 200. Accompanying that movement, the object B that is placed on the cover 430 which covers the sitting portion 210 of the seat 200 moves toward the posterior side of the seat 200. At the same time, accompanying the detection of the object B, the cover portion of the storage box 300 is opened.

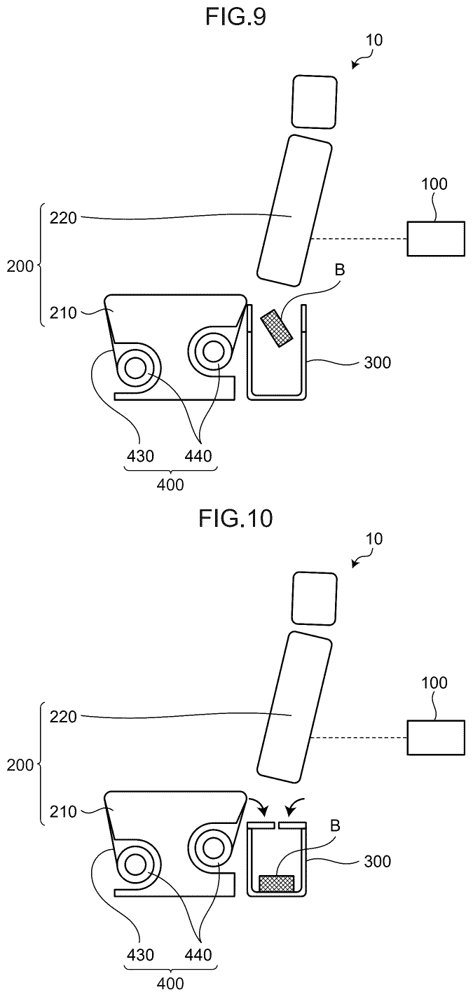

Then, the object retrieval and storage device 10 switches to a third state as illustrated in FIG. 9. FIG. 9 is a schematic diagram illustrating a third state of the object retrieval and storage device according to the second embodiment of the present application. That is, since the object B which is placed on the sitting portion 210 of the seat 200 is moved to the posterior side of the seat 200 due to the movement of the cover 230, the object B slips from the sitting portion 210 of the seat 200 and is put into the storage box 300 provided below the backrest 220 of the seat 200.

Then, the object retrieval and storage device 10 according to the second embodiment switches to a fourth state as illustrated in FIG. 10. FIG. 10 is a schematic diagram illustrating a fourth state of the object retrieval and storage device according to the second embodiment of the present application. Thus, once it is confirmed that the object B is put into the storage box 300, the cover portion of the storage box 300 is closed. For that reason, without gaining the authentication to access the storage box 300, the user cannot insert a hand inside the storage box 300.

As a result, even when the object B is left on the seat 200, the object B can be automatically detected and, by moving the cover 430 of the seat 200, the object B can be retrieved and safely stored in the storage box 300.

### Configuration of the Control Device

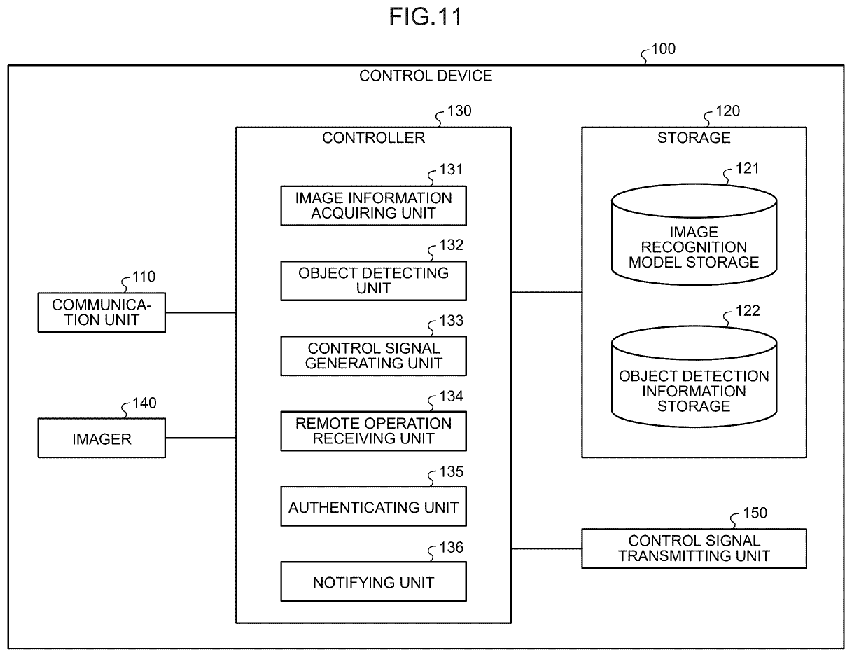

Explained below with reference to FIG. 11 is a configuration of the control device 100 according to the present application. FIG. 11 is a diagram illustrating an exemplary configuration of the control device 100 of the object retrieval and storage device according to the present application. As illustrated in FIG. 11, the control device 100 includes a communication unit 110, a storage 120, a controller 130, an imager 140, and a control signal transmitting unit 150. An explanation about those constituent elements is given below in a sequential manner.

The communication unit 110 is a communication module with which the control device 100 performs communication with external devices. The communication unit 110 is responsible for the communication of a variety of data with external devices according to wireless communication or wired communication. In the case of performing wireless communication, the communication unit 110 can be implemented using a communication antenna, an RF circuit (RF stands for Radio Frequency), or a wireless LAN card (LAN stands for Local Area Network). In the case of performing wired communication, the communication unit 110 can include, for example, a network interface card (NIC) having wired LAN terminals, a signal transmission circuit, or some other type of communication processing circuit.

The storage 120 is a memory device used for storing a variety of information. The storage 120 includes a main memory device and an auxiliary memory device. For example, the main memory device can be implemented using a semiconductor memory device such as a random access memory (RAM), a read only memory (ROM), or a flash memory. For example, the auxiliary memory device can be implemented using a hard disk, a solid state drive (SSD), or an optical disk.

As illustrated in FIG. 11, the storage 120 includes an image recognition model storage 121 and an object detection information storage 122. In the following explanation, an example of the information stored in those constituent elements is explained in a sequential manner.

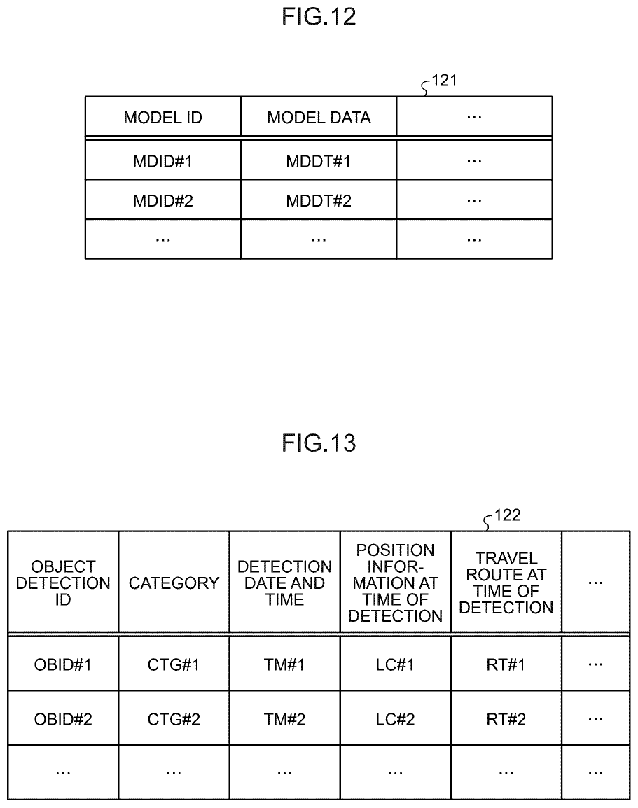

The image recognition model storage 121 is used to store information related to an image recognition model. Explained below with reference to FIG. 12 is an example of the information stored in the image recognition model storage 121. FIG. 12 is a diagram illustrating an example of the information stored in the image recognition model storage in the control device 100 according to the present application.

In the example illustrated in FIG. 12, in the image recognition model storage 121, the information related to items “model ID” and “model data” is stored in a corresponding manner.

The item “model ID” represents an identifier that enables identification of an image recognition model, and that is expressed in a form of character strings and/or numbers. The item “model data” represents data of the image recognition model identified by each model ID specified in the item “model ID”. Meanwhile, an image recognition model can be a convolutional neural network (CNN). Each of model data specified in the item “model data” contains, for example, a variety of information such as coupling information about a manner of coupling among nodes included in each of multiple layers constituting a deep neural network, and coupling parameters that are multiplied to numerical values input and output among the coupled nodes.

In FIG. 12 is illustrated an example in which model data “MDDT #1” is stored that corresponds to the deep learning model identified by a model ID “MDID #1”.

The information stored in the image recognition model storage 121 is not limited to the information related to the items “model ID” and “model data”, and the information related to other arbitrary image recognition models can also be stored.

The object detection information storage 122 is used to store information related to object detection information. Explained below with reference to FIG. 13 is an example of the information stored in the object detection information storage 122. FIG. 13 is a diagram illustrating an example of the information stored in the object detection information storage 122 in the control device 100 according to the present application.

As illustrated in the example in FIG. 13, in the object detection information storage 122, the information related to items “object detection ID”, “category”, “detection date and time”, “position information at time of detection”, and “travel route at time of detection” is stored in a corresponding manner.

The item “object detection ID” represents an identifiers that enables identification of the object detection, and that is expressed in the form of character strings or numbers. The item “category” represents information indicating a category of the object identified by each object detection ID specified in the item “object detection ID”. The item “detection date and time” represents information indicating a date and a time of detection of the object identified by each object detection ID specified in the item “object detection ID”. The item “position information at time of detection” represents information indicating a position of detection of the object identified by each object detection ID specified in the item “object detection ID”. The item “travel route at time of detection” represents information indicating a travel route at the time of detection of the object identified by each object detection ID specified in the item “object detection ID”.

In FIG. 13 is illustrated an example in which the object identified by an object detection ID “OBID #1” belongs to a category “CTG #1”, is detected at a detection date and a time “TM #1”, has position information “LC #1” at the time of detection thereof, and corresponds to a travel route “RT #1” at the time of detection thereof.

Meanwhile, the information stored in the object detection information storage 122 is not limited to the information related to the items “object detection ID”, “category”, “detection date and time”, “position information at time of detection”, and “travel route at time of detection”. Thus, other arbitrary object detection information can also be stored.

The controller 130 is a controller that controls the control device 100. The controller 130 is implemented when a central processing unit (CPU) or a micro processing unit (MPU) executes various computer programs stored in the storage 120 with using a RAM as a work area. Alternatively, for example, the control unit 130 can be implemented using an integrated circuit such as an application specific integrated circuit (ASIC) or a field programmable gate array (FPGA).

An image information acquiring unit 131 acquires image data that is captured by the imager 140. That is, once the imager 140 captures image data, the image information acquiring unit 131 acquires that image data and stores it in the storage 120.

Based on the image data, an object detecting unit 132 determines whether or not an object is present on the seat. For example, the object detecting unit 132 can implement image recognition to detect an object placed on the seat 200 and can perform an operation to classify the object and recognize the category thereof. For example, an object recognition technology using CNN can be implemented.

A control signal generating unit 133 generates a control signal for causing movement of the movable portion. More particularly, the control signal generating unit 133 decides a signal that includes a time series variation of a voltage value to be applied to the movable portion, and generates that signal as the control signal. After generating the control signal, the control signal generating unit 133 causes the control signal transmitting unit 150 to transmit the control signal to the movable portion.

A remote operation receiving unit 134 receives operation information from the user terminal 500. For example, as the operation information, the remote operation receiving unit 134 receives authentication information that is input by the user from the user terminal 500.

In response to an access request issued by the user, an authenticating unit 135 authenticates the access of the user with respect to the storage box 300. For example, the authenticating unit 135 can display an authentication information input screen in the user terminal 500, and receive an input of the authentication information from the user. For example, the authentication information can be about an account ID of the user, the get-off time, and the travel route, and the authentication can be performed by collating the authentication information with the information stored in the object detection information storage 122. If the collation indicates a matching result, the authenticating unit 135 can send, to the storage box 300, a control signal for opening the storage box 300. As a result, the storage box 300 opens.

When it is detected that the object is present on the seat 200, a notifying unit 136 notifies the user terminal 500 about the same. More particularly, the notifying unit 136 displays, in the user terminal 500, the information about the category of the object detected by the object detecting unit 132, the date and the time of the detection, and the position information at the time of the detection.

The imager 140 includes an optical element and an imaging element. The optical element constitutes an optical system such as a lens, a prism, or a filter. The imaging element converts the light, which has fallen thereon via the optical element, into an image signal representing an electrical signal. The imaging element can be, for example, a CCD sensor (CCD stands for Charge Coupled Device) or a CMOS sensor (CMOS stands for Complementary Metal Oxide Semiconductor).

The control signal transmitting unit 150 transmits, to the movable portion, the control signal generated by the control signal generating unit 133. The control signal transmitting unit 150 can be implemented using a variety of electrical wiring. For example, the control signal transmitting unit 150 can be implemented using a control signal cable that is formed by bundling multiple electrical wires, in which a conductor such as copper is covered by an insulating material, and by covering the bundle by a sheet of polyvinyl chloride (PVC) having electrical insulating property. That is, the control signal transmitting unit 150 is connected to the movable portion using electrical wiring.

### Configuration of the User Terminal

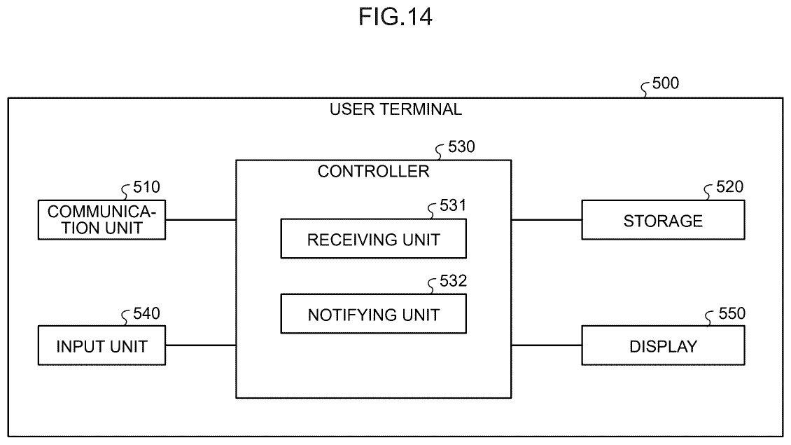

Explained below with reference to FIG. 14 is a configuration of the user terminal 500 according to the present application. FIG. 14 is a diagram illustrating an exemplary configuration of the user terminal according to the present application. As illustrated in FIG. 14, the user terminal 500 according to the present application includes a communication unit 510, a storage 520, a controller 530, an input unit 540, and a display 550. An explanation about those constituent elements is given below in a sequential manner.

The communication unit 510 is a communication module with which the user terminal 500 performs communication with external devices. The communication unit 510 is responsible for the communication of a variety of data with external devices according to wireless communication or wired communication. In the case of performing wireless communication, the communication unit 510 can be implemented using a communication antenna, an RF circuit, or a wireless LAN card. In the case of performing wired communication, the communication unit 510 can include, for example, an NIC having wired LAN terminals; a signal transmission circuit; or some other type of communication processing circuit.

The storage 520 is a memory device used in storing a variety of information. The storage 520 includes a main memory device and an auxiliary memory device. For example, the main memory device can be implemented using a semiconductor memory device such as a RAM, a ROM, or a flash memory. For example, the auxiliary memory device can be implemented using a hard disk, an SSD, or an optical disk.

The controller 530 is a controller that controls the user terminal 500. The controller 530 is implemented when a CPU or an MPU executes various computer programs stored in the storage 520 with using a RAM as a work area. Alternatively, for example, the controller 530 can be implemented using an integrated circuit such as an ASIC or an FPGA.

As illustrated in FIG. 14, the controller 530 includes a receiving unit 531 and a notifying unit 532. The controller 530 reads and executes computer programs (software) from the storage 520 so as to implement functions and perform processing. Alternatively, the functions of the controller 530 can be implemented using an electronic circuit. Meanwhile, the controller 530 can perform the processing using a single CPU, or can include multiple CPUs and can perform the processing in parallel across the CPUs. An explanation about the constituent elements is given below in a sequential manner.

The receiving unit 531 receives input of the authentication information from the user. For example, the receiving unit 531 can display an input screen in the display 550, and receive input of the authentication information from the user. Upon receiving the authentication information (explained later) that is input in the input unit 540, the receiving unit 531 sends the authentication information to the server device 600 via the communication unit 510.

The notifying unit 532 notifies the user about the fact that the object is detected. More particularly, the notifying unit 532 displays, in the display 550 (explained later), the information about the category of the detected object, the date and the time of the detection, and the position information at the time of the detection.

The input unit 540 receives a variety of operation information. For example, the input unit 540 can receive a variety of operation information via various switches, or a keyboard, or a mouse. Alternatively, the input unit 540 can receive a variety of operation information via a display screen such as a touch-sensitive panel.

The display 550 displays a variety of information. For example, the display 550 can display a screen indicating the fact that an object is detected. The display 550 can be implemented using a liquid crystal display, an organic EL display, or a micro LED display.

### Configuration of the Server Device

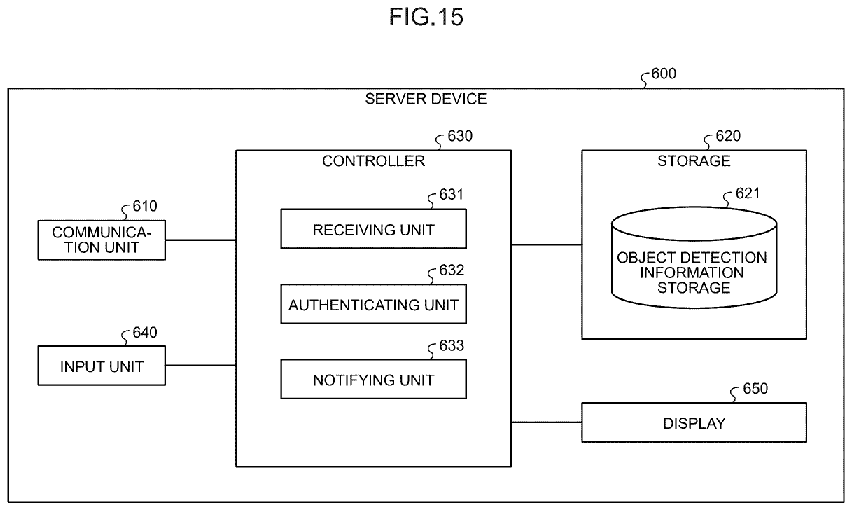

Explained below with reference to FIG. 15 is a configuration of the server device 600 according to the present application. FIG. 15 is a diagram illustrating an exemplary configuration of the server device 600 according to the present application. As illustrated in FIG. 15, the server device 600 according to the present application includes a communication unit 610, a storage 620, a controller 630, an input unit 640, and a display 650. An explanation about those constituent elements is given below in a sequential manner.

The communication unit 610 is a communication module that performs communication with external devices. The communication unit 610 is responsible for the communication of a variety of data with external devices according to wireless communication or wired communication. In the case of performing wireless communication, the communication unit 610 can be implemented using a communication antenna, an RF circuit, or a wireless LAN card. In the case of performing wired communication, the communication unit 610 can include, for example, an NIC having wired LAN terminals.

The storage 620 is a memory device used in storing a variety of information. The storage 620 includes a main memory device and an auxiliary memory device. For example, the main memory device can be implemented using a semiconductor memory device such as a RAM, a ROM, or a flash memory. For example, the auxiliary memory device can be implemented using a hard disk, an SSD, or an optical disk.

As illustrated in FIG. 15, the storage 620 includes an object detection information storage 621. The items of information stored in the object detection information storage 621 are same as the items of information stored in the object detection information storage 122 of the control device 100. Hence, that explanation is not given again.

The controller 630 is a controller that controls the server device 600. The controller 630 is implemented when a CPU or an MPU executes various computer programs stored in the storage 620 with using a RAM as a work area. Alternatively, for example, the controller 630 can be implemented using an integrated circuit such as an ASIC or an FPGA.

As illustrated in FIG. 15, the controller 630 includes a receiving unit 631, an authenticating unit 632, and a notifying unit 633. The controller 630 reads and executes computer programs (software) from the storage 620 so as to implement functions and perform processing. Alternatively, the functions of the controller 630 can be implemented using an electronic circuit. Meanwhile, the controller 630 can perform the processing using a single CPU, or can include multiple CPUs and can perform the processing in parallel across the CPUs. An explanation about the constituent elements is given below in a sequential manner.

The receiving unit 631 receives input of the authentication information from the user. For example, the receiving unit 631 can receive the input information of the user from the user terminal 500 via the communication unit 610.

In response to an access request issued by the user, the authenticating unit 632 authenticates the access of the user with respect to the storage box 300. For example, when the user terminal 500 is not able to directly communicate with the object retrieval and storage device 10, the authenticating unit 632 authenticates the access of the user. If the collation of the authentication information with the information stored in the object detection information storage 122 indicates a matching result, the authenticating unit 632 sends, to the storage box 300, a control signal for opening the storage box 300. As a result, the storage box 300 opens.

When it is detected that an object is present on the seat 200, the notifying unit 633 notifies the user terminal 500 about the same. More particularly, when the object retrieval and storage device 10 could not notify the user terminal 500 using the communication unit 110, the notifying unit 633 notifies the user terminal 500. The notifying unit 633 displays, in the user terminal 500, the information about the category of the object detected by the object detecting unit 132, the date and the time of the detection, and the position information at the time of the detection.

The input unit 640 receives a variety of operation information. For example, the input unit 640 can receive a variety of operation information via various switches, or a keyboard, or a mouse. Alternatively, the input unit 640 can receive a variety of operation information via a display screen such as a touch-sensitive panel.

The display 650 displays a variety of information. For example, the display 650 can display a graphical user interface (GUI) for enabling the operation of the server device 600. The display 650 can be implemented using a liquid crystal display, an organic EL display, or a micro LED display.

### Configuration and Effects

The object retrieval and storage device 10 according to the present application includes: a storage box 300 in which an object B is stored; a retrieval mechanism 400 configured to move the object B which is present on a seat 200 to retrieve the object B into the storage box 300; an imager 140 configured to capture an image which includes a condition of the seat 200; and an object detecting unit 132 configured to, based on the captured image, determine whether or not the object B is present on the seat 200, wherein the retrieval mechanism 400 is further configured to, when the object detecting unit determines that the object B is present on the seat 200, move the object B to put the object into the storage box 300.

With such a configuration, when the object B is present on the seat 200, the object B present on the seat 200 can be moved and put into the storage box 300. Thus, the object B can be automatically moved to and stored in a safe place. Hence, it becomes possible to provide the object retrieval and storage device 10 that not only appropriately retrieves an object but is also capable of storing the object.

In the object retrieval and storage device 10 according to the present application, the retrieval mechanism 400 includes: a sliding portion 420 configured to serve as a constraint on sliding movement of the seat 200; a fulcrum portion 410 configured to serve as a fulcrum point for rotational movement of the seat 200, and a movable portion configured to, after the seat 200 is slid along the sliding portion 420, rotate the seat 200 around the fulcrum portion 410, wherein the retrieval mechanism 400 is further configured to retrieve the object B that is present on the seat 200 into the storage box 300 by sliding the seat 200 along the sliding portion 420 and then rotating the seat 200 around the fulcrum portion 410.

With such a configuration, as a result of firstly sliding the seat 200 and then rotating it, the object B that is present on the seat 200 can be retrieved into the storage box 300. Hence, it becomes possible to provide the object retrieval and storage device 10 that not only appropriately retrieves an object but is also capable of storing the object.

In the object retrieval and storage device 10 according to the present application, the retrieval mechanism 400 includes: a cover 430 that covers the seat 200; and circular rollers 440 configured to wind the cover 430, wherein the retrieval mechanism 400 is further configured to retrieve the object B which is placed on the cover 430 of the seat 200 into the storage box 300 by rotating the rollers 440 to wind the cover 430 of the seat 200.

With such a configuration, the rollers 440 are rotated and the cover 430 of the seat 200 is wound, so that the object B present on the cover 430 of the seat 200 can be moved and can be retrieved into the storage box 300. Hence, it becomes possible to provide the object retrieval and storage device 10 that not only appropriately retrieves an object but is also capable of storing the object.

In an object retrieval and storage device 10 that includes: a storage box 300 in which an object B is stored; a retrieval mechanism 400 configured to move the object B which is present on a seat 200 to retrieve the object B into the storage box 300; and an imager 140 configured to capture an image which includes a condition of the seat 200, an object retrieval and storage method is implemented that includes determining, based on the captured image, whether or not the object B is present on the seat 200; and moving the object B to put the object B into the storage box 300 when the object B is determined to be present on the seat 200.

With such a configuration, when the object B is present on the seat 200, the object B present on the seat 200 can be moved and put into the storage box 300. Thus, the object B can be automatically moved to and stored in a safe place. Hence, it becomes possible to provide the object retrieval and storage method that not only enables appropriately retrieving an object but also enables storing the object.

In an object retrieval and storage device 10 that includes: a storage box 300 in which an object B is stored; a retrieval mechanism 400 configured to move the object B which is present on a seat 200 to retrieve the object B into the storage box 300; and an imager 140 configured to capture an image which includes a condition of the seat 200, a computer program stored in a non-transitory storage medium causes a computer to execute: determining, based on the captured image, whether or not the object B is present on the seat 200; and moving the object B to put the object B into the storage box 300 when the object B is determined to be present on the seat 200.

With such a configuration, when the object B is present on the seat 200, the object B present on the seat 200 can be moved and put into the storage box 300. Thus, the object B can be automatically moved to and stored in a safe place. Hence, it becomes possible to provide the computer program that not only enables appropriately retrieving an object but also enables storing the object.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

According to the present application, it becomes possible to provide an object retrieval and storage device, an object retrieval and storage method, and a non-transitory storage medium that not only enable appropriately retrieving an object but also enable storing the object.

What is claimed is:

1. An object retrieval and storage device comprising:
a storage box in which an object is stored;
a retrieval mechanism configured to move the object which is present on a seat to retrieve the object into the storage box;
an imager configured to capture an image which includes a condition of the seat; and
an object detecting unit configured to, based on the captured image, determine whether or not the object is present on the seat, wherein
the retrieval mechanism is further configured to, when the object detecting unit determines that the object is present on the seat, move the object to put the object into the storage box.

2. The object retrieval and storage device according to claim 1, wherein
the retrieval mechanism comprises:
a sliding portion configured to serve as a constraint on sliding movement of the seat;
a fulcrum portion configured to serve as a fulcrum point for rotational movement of the seat, and
a movable portion configured to, after the seat is slid along the sliding portion, rotate the seat around the fulcrum portion, wherein
the retrieval mechanism is further configured to retrieve the object that is present on the seat into the storage box by sliding the seat along the sliding portion and then rotating the seat around the fulcrum portion.

3. The object retrieval and storage device according to claim 1, wherein
the retrieval mechanism comprises:
a cover that covers the seat; and
circular rollers configured to wind the cover, wherein
the retrieval mechanism is further configured to retrieve the object which is placed on the cover of the seat into the storage box by rotating the rollers to wind the cover of the seat.

4. An object retrieval and storage method implemented in an object retrieval and storage device that includes:
a storage box in which an object is stored;
a retrieval mechanism configured to move the object which is present on a seat to retrieve the object into the storage box; and
an imager configured to capture an image which includes a condition of the seat,
the object retrieval and storage method comprising:
determining, based on the captured image, whether or not the object is present on the seat; and
moving the object to put the object into the storage box when the object is determined to be present on the seat.

5. A non-transitory storage medium that stores a computer program for an object retrieval and storage device that includes:
a storage box in which an object is stored;
a retrieval mechanism configured to move the object which is present on a seat to retrieve the object into the storage box; and
an imager configured to capture an image which includes a condition of the seat,
the program causing a computer to execute:
determining, based on the captured image, whether or not the object is present on the seat; and
moving the object when it is determined that the object is present on the seat to put the object into the storage box when the object is determined to be present on the seat.
